(19) United States
(12) Patent Application Publication
(10) Pub. No.: US 2002/0121303 A1
(43) Pub. Date: Sep. 5, 2002

(54) Apparatus for a steam trap guard and related method of use

(76) Inventor: Michael R. Sheely, Cypress, TX (US)

Correspondence Address: William P. Ramey, III, Suite 1800, 1900 West Loop South, Houston, TX, 77027, US

(21) Appl. No.: 09/798,156

(22) Filed: Mar. 2, 2001

(51) Int. Cl. F16T 1/00

(52) U.S. Cl. 137/377

(57) ABSTRACT

An apparatus and method of use is disclosed for protecting an operator from accidental exposure and/or contact with a hot pipe or steam trap. The methods and apparatuses herein disclosed allow for the accessibility of the steam trap while the apparatus is installed about a pipe.

### TECHNICAL FIELD

The present invention relates generally to a steam trap guard. More particularly, the present invention relates to a cover about a steam trap to protect operators from accidental contact with the steam trap while allowing access to the steam trap.

### BACKGROUND ART

In recent years much attention has been focused on industrial accidents in an effort to eliminate these accidents from the workplace. A typical worker faces daily danger and risk from injuries from a cut or bruise to death. These dangers arise from all manner of instrumentalities, including, but not limited to, moving machinery, hot pipes, open flames, repetitive motion and dangerous chemicals.

In response to such dangers, workplace safety regulations have evolved to require certain minimum safeguards for workplaces. For example, workers that face a risk of potential exposure to moving machinery are often required to wear gloves and eye protection. As well, workers exposed to risk of chemical exposure, or that work with flammable chemicals, are often required to wear flame retardant clothing and eye and/or face protection. Further, workplace safety has developed, for both worker protection reasons and economical reasons, insulation to cover pipes.

Insulation on a pipe has proved very economical for pipes carrying heated products in decreasing the amount of heat loss to the environment. One particular type of pipe in which insulation is commonly used is the steam line or steam pipe. It is very common to have steam pipes running throughout an industrial application for varying reasons, such as, but not limited to, heating product and supplying steam. Almost the entirety of these steam pipes, or lines, are insulated for the aforementioned reasons. However, a commonality to the majority of steam pipes or lines is the need for a steam trap and by force of fact, these steam traps will normally not be insulated. Unfortunately, a hot steam trap produces frequent industrial accidents by the unintended contact of the steam trap by a user. The burns that may result from these steam traps can be quite severe and permanently disfiguring, as the steam that may be conveyed in such pipes could easily be at a temperature in excess of 450 degrees Fahrenheit. Accordingly, an un-insulated steam trap may be at an elevated temperature approximating the temperature of the steam conveyed.

While it is possible to insulate a steam trap, this is not preferred because frequent access must be had to the steam trap to allow the release of built up condensate within the trap. The necessity of constantly applying and removing insulation about the area of a steam trap would be very time consuming and labor intensive. However, the risk exposure of an un-insulated steam trap is very high. Especially considering that personnel are often required to be working in the vicinity of the steam trap. Accordingly, the art field has sought a guard that may be placed or fitted about a steam trap to provide protection from unintentional contact with the steam trap.

### SUMMARY OF THE INVENTION

The present invention generally relates to a steam trap guard. The steam trap guard providing some protection from accidental contact with a steam trap.

This summary is not intended to be a limitation with respect to the features of the invention as claimed, and this and other objects can be more readily observed and understood in the detailed description of the preferred embodiment and the claims.

### BRIEF DESCRIPTION OF DRAWINGS

For a further understanding of the nature and objects of the present invention, reference should be made to the following detailed description, taken in conjunction with the accompanying drawings, in which like elements are given the same or analogous reference numbers and wherein:

FIG. 1 is an illustration of an embodiment of the present invention.

FIG. 2a is an illustration of the embodiment of FIG. 1 from a side.

FIG. 2b is an illustration of the embodiment of FIG. 1 from a different perspective from the side.

FIG. 3 is an illustration of an alternate embodiment of the present invention.

FIG. 4 is an illustration of an alternate embodiment of the present invention.

FIG. 5a is an illustration of an alternate clamping mechanism and embodiment for the present invention.

FIG. 5b is an illustration of the clamping mechanism of FIG. 5a.

FIG. 6a is an illustration of a cross sectional view of an embodiment of the present invention installed on a pipe.

FIG. 6b is an illustration of an alternate embodiment of the present invention installed on a pipe.

FIG. 7 is an alternate embodiment of the present invention.

### GENERAL DESCRIPTION AND PREFERRED MODE FOR CARRYING OUT THE INVENTION

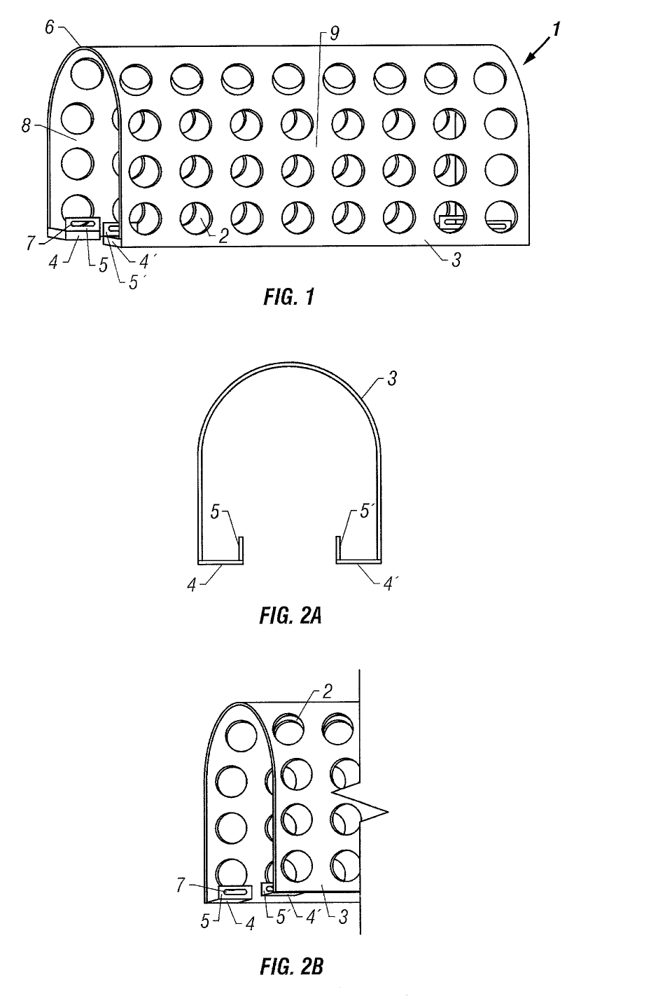

Now referring to FIG. 1, an illustration of an embodiment of the present invention, several advantages to the present invention may become obvious. Steam Trap guard 1 is generally composed of a sheet 3 and connection(s) 4 with perforations 2. An embodiment of the present invention has sheet 3 in an arcuate shape 6 for installation about a steam trap. However, various other embodiments of the present invention utilize differing shapes for sheet 3 as will become more readily apparent through the remainder of this disclosure.

Connection(s) 4 generally extend from a portion of sheet 3 along or into inside side 8. Connection(s) 4 may extend any length from inside side 8. The length of connection 4 is generally determined from several factors, including, but not limited to the size of the pipe, the temperature of the steam conveyed in the pipe and/or the size of the steam trap. However, various other factors may be used for determining the length of connection(s) 4 and such factors will be readily known and apparent to those of ordinary skill in the art. In the embodiment of FIG. 1, connection(s) 4 has a portion, or opposing pipe connection 5, that is generally in a parallel planar orientation to an opposing pipe connection 5′ that extends from an opposing connection 4′. In this embodiment, a slot 7 is formed in the opposing pipe connection and may be used for a connection member such as a band, screw or wire. The connection member may be passed through slot 7 and secured about a pipe. In an embodiment, opposing pipe connection 5 and opposing pipe connection 5′ may have a single connection member passed through both and securing about a pipe.

In another embodiment, a screw or other insertable member may be secured through slot 7 and into an insulation surrounding a pipe. A screw type connection member may be advantageous in an area where the insulation about a pipe is very thick or where an operator would like to make the steam trap guard more permanently affixed to a pipe. In coordination with a screw type connection member, a base may be used along the insulation for better securing the steam trap guard while not destroying or significantly altering the insulation.

Perforation(s) 2 are illustrated as circular, but may be of any shape desired by an operator such as triangular, quadrangular or any other polygonal shape. A purpose of the perforations may be to allow for a dissipation of heat from a steam trap. Another purpose may be for insulation for the steam trap such as in areas where a cold breeze may act to freeze the condensed water in a steam trap. Accordingly, various other embodiments of the present invention utilize a sheet that is not perforated, as more fully described below. In furtherance of providing insulation and access to a steam trap, various embodiments of the present invention utilize a layer of insulation about a portion of sheet 2.

An embodiment of the present invention utilizes a metal as sheet 3, connection 4 and opposing pipe connection 5. However, various other embodiments may utilize other materials. If an embodiment of the present invention is secured directly to a pipe then the material of choice should be a material that can withstand the direct temperature of a steam pipe. If an embodiment of the present invention is secured about installation on a pipe then the material of choice may be chosen from the materials that can withstand the temperatures of an outer surface of the installation and the radiant heat in the air about the steam trap.

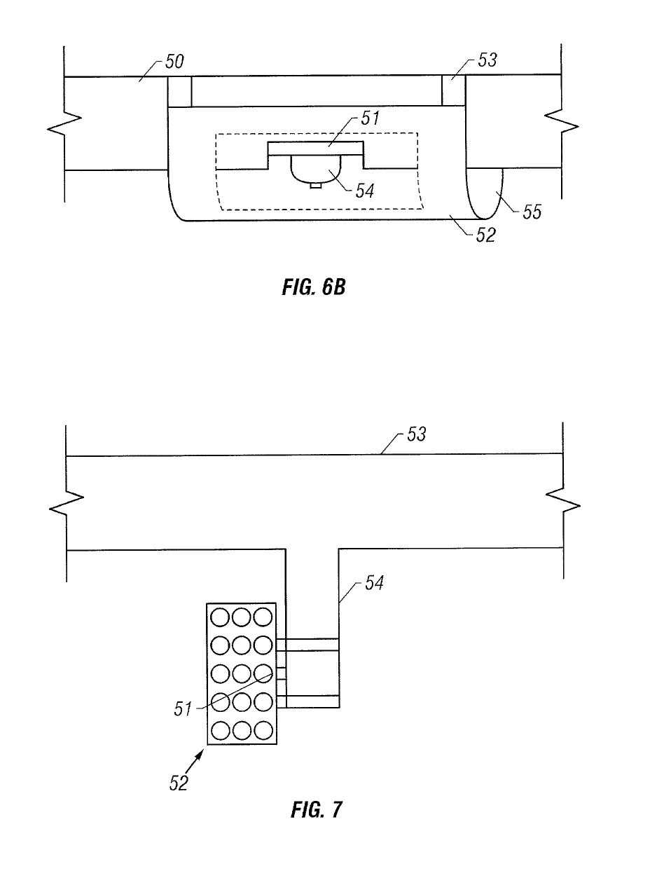

The securing of the steam trap guard will be more fully described as in reference to FIGS. 6a and 6b, however, generally, the steam trap guard is secured about the steam trap such that sheet 3 is not in contact with the steam trap. An embodiment of the present invention has sheet 3 a sufficient distance from the steam trap so as not to conduct an excessive amount of the heat from the steam trap to sheet 3, whereby the steam trap guard is cooler than the steam trap. In another embodiment, the steam trap guard is very much cooler than the steam trap. Further, the embodiment of FIG. 1 may be secured about the steam trap as described above with a band or clasp.

Now referring to FIG. 2a, an illustration of the embodiment of FIG. 1 from a side, a connection of this embodiment may become apparent. Sheet 3 is generally arcuate in a shape of a horseshoe. A connection 4 and a connection 4′ generally extend from about opposing ends of sheet 3 towards an interior of this embodiment. The generally parallel planar orientation of opposing pipe connection(s) 5 and 5′ is more clearly illustrated. In securing embodiments of the present invention, embodiments of the steam trap guard will generally be fitted about a pipe such that opposing pipe connection(s) 5 and 5′ generally surround the pipe.

Now referring to FIG. 2b, an illustration of the embodiment of FIG. 1 from a different perspective from the side, the interaction of opposing pipe connection(s) 5 and 5′ may be more clearly seen. Other connections may be utilized and will be more fully discussed below.

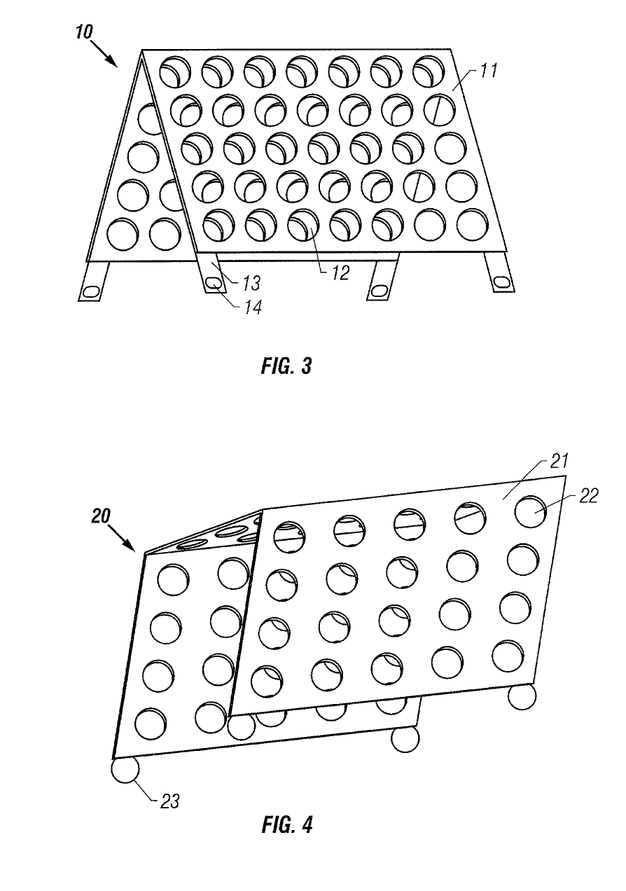

Now referring to FIG. 3, an illustration of an alternate embodiment of the present invention, the range and scope of the present invention may become more readily apparent. In this alternate embodiment of steam trap guard 10, sheet 11 has a generally triangular orientation and/or configuration. Connection(s) 13 generally extend in about a plane of sheet 12 with a slot 14 about a portion of connection 13 for securing this embodiment as heretofore discussed and as will be more fully discussed below.

Now referring to FIG. 4, an illustration of an alternate embodiment of the present invention, steam trap guard with a quadrangular orientation and/or configuration is disclosed.

Connection(s) 23 is illustrated in an alternate configuration of a loop or hook. Connection(s) 23 may be secured about a pipe in any manner common in the art as well as those manners herein disclosed.

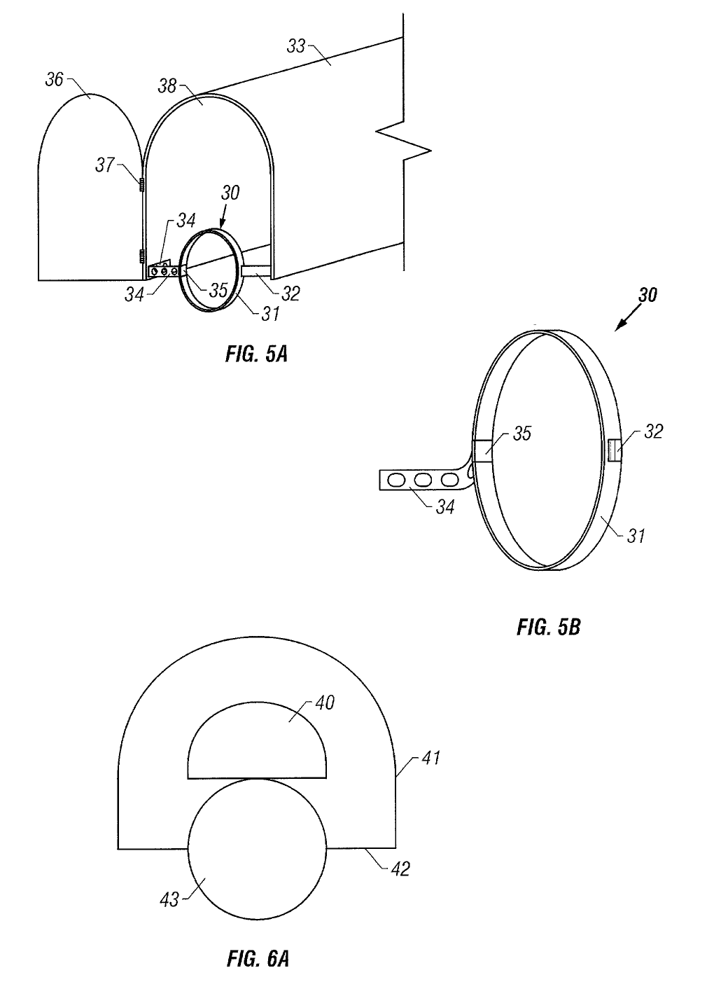

Now referring to FIG. 5a, an illustration of an alternate clamping mechanism and embodiment for the present invention, an embodiment with a non-perforated sheet 33 is illustrated. This embodiment further discloses a door 36 on an end of the embodiment for selective access to a steam trap. Door 36 is connected to sheet 33 by any means common in the art, such as hinge 37. An insulation layer 38 may be incorporated with embodiments to provide insulation to a steam trap. As aforementioned, this may be advantageous for an operator who desires insulation about a steam trap while allowing for access.

A pipe connection member 30 is disclosed that is secured about a portion of sheet 33. The pipe connection 30 may be adjustably fitted about a pipe and tightened to a secure fit. The tightening mechanism of such a device and is well known in the art and the disclosure herein incorporates all such mechanisms.

Now referring to FIG. 5b, an illustration of the clamping mechanism of FIG. 5a, the universality of the present clamping mechanism may be seen. Generally, band 31 is fitted about a pipe after disconnecting band 31 about mechanism 35. After placing band 31 along a pipe, band 31 may be closed through mechanism 35.

Now referring to FIG. 6a, an illustration of a cross sectional view of an embodiment of the present invention installed on a pipe, the orientation of a steam guard on a pipe may more clearly illustrated. A connection 42 extends from sheet 41 to about pipe 43 and is secured by any manner herein disclosed as well as those other manners that are known in the art. Sheet 41 generally is placed such that it extends above steam trap 40 an provides room for access and/or heat dissipation.

Now referring to FIG. 6b, an illustration of an alternate embodiment of the present invention installed on a pipe, a cut-away window is illustrated to allow for a better understanding of the installation of the present invention. The cut away window, illustrated by the dashed line, illustrates how embodiments of the present invention may be installed. In this embodiment, insulation 50 is about pipe 51, except for an area about steam trap 54. As mentioned, it is common not to insulate an area about a steam trap to allow for an operator to have access to the steam trap for various purposes, such as maintenance and draining. In the present embodiment, an operator may have access to the steam trap through an end, such as end 55, while being protected from accidental contact with the exposed pipe and steam trap.

Now referring to FIG. 7, an illustration of an alternate embodiment of the present invention, an embodiment of the present invention may be seen. A pipe 53 may have a drain pipe 54 where a steam trap 51 is connected. Steam trap guard 52 may be hooked about the pipe as described above. Other embodiments of may connect a steam trap guard about the end of a pipe. Generally, embodiments of the present invention may be secured about any steam trap to provide protection for an operator.

A method of protecting an operator from accidental contact with an exposed pipe or steam trap is also within the scope of the present invention. The method generally encompasses obtaining a sheet that is at least partially pliable; applying the sheet about a steam trap; and, securing the sheet about the steam trap. Various other modifications to the method may be made as is fully disclosed herein.

While various embodiments have been disclosed, the scope of the invention is not limited hereto. For example, the various connections disclosed herein use varying connections and sheets that may be interchangeably used with all embodiments. Further, the inclusion of insulation, or removable insulation, may be incorporated with all embodiments.

What is claimed is:

1. An steam trap guard that protects a user while allowing access to the steam trap, comprising:
a sheet having an inside side, an outside side, a first pair of opposing sides and a second pair of opposing sides; and,
a first pair of opposing pipe connections connected about one of the first pair of opposing sides and a second pair of opposing pipe connections connected about the other of the first pair of opposing sides.

2. The steam trap guard of claim 1 wherein the first and second pair of opposing pipe connections generally extend below a plane of the inside side.

3. The steam trap guard of claim 1 wherein the pipe connections further comprise a slot about a portion of each of the first and second pipe connections.

4. The steam trap guard of claim 1 wherein the sheet is generally in an arcuate shape.

5. The steam trap guard of claim 2 wherein a portion of the first pair of opposing pipe connections are substantially planar and a portion of the second pair of opposing pipe connections are substantially planar.

6. The steam trap guard of claim 5 further comprising slots about the portion of the first and second pair of opposing pipe connections.

7. The steam trap guard of claim 6 further comprising a band that extends through a portion of the slots for connecting the steam trap guard to a pipe about a steam trap.

8. The steam trap guard of claim 1 wherein the sheet is perforated.

9. The steam trap guard of claim 1 further comprising a clasp about the first pair of opposing pipe connectors and a clasp about the second pair of pipe connectors.

10. The steam trap guard of claim 9 wherein the clasp of the first opposing pair of pipe connectors may be clasped together.

11. The steam trap guard of claim 1 wherein the steam trap guard is an in-line steam trap guard whereby the steam trap guard may be releasably secured about a steam trap.

12. A guard, comprising a perforated sheet secured about a steam trap.

13. The guard of claim 12 wherein the perforated sheet is U-shaped, the U-shape generally covering the steam trap.

14. The guard of claim 13 wherein the perforated sheet is open on a first end whereby an operator may have access to the steam trap.

15. The guard of claim 12 further comprising a first connection means about a portion of the perforated sheet.

16. The guard of claim 12 further comprising an insulation layer.

17. The guard of claim 12 further comprising a band about the first connection.

18. The guard of claim 14 further comprising a door about the first end.

19. A method of protecting an operator from accidental exposure to a steam rap comprising the steps of:
obtaining a sheet that is at least partially pliable;
applying the sheet about a steam trap; and,
securing the sheet about the steam trap.

20. The method of claim 19 wherein the sheet is U-shaped.

21. The method of claim 19 wherein applying the sheet further comprises placing the sheet about a steam trap such that access may be had to the steam trap.

22. The method of claim 19 wherein the step of securing the steam trap further comprises clamping a connection means about a portion of the sheet.

23. The step of obtaining a sheet, further comprising the step of perforating the sheet.
